(19) United States
(12) Patent Application Publication
(10) Pub. No.: US 2010/0248198 A1
(43) Pub. Date: Sep. 30, 2010

(54) Computer-based first-person behavioral change methodology

(75) Inventors: William H. Seidman, Lake Oswego, OR (US); Michael L. McCauley, Peoria, AZ (US)

Correspondence Address: ROBERT D. VARITZ, P.C., 4915 SE 33RD PLACE, PORTLAND, OR, 97202, US

(73) Assignee: Cerebyte, Inc.

(21) Appl. No.: 12/456,213

(22) Filed: Jun. 12, 2009

Related U.S. Application Data
(60) Provisional application No. 61/132,236, filed on Jun. 16, 2008.

(51) Int. Cl. G09B 19/00

(52) U.S. Cl. 434/236

(57) ABSTRACT

A first-person, field-of-endeavor-associated method for transforming, toward positive deviance, a behavioral change-candidate's performance characteristics in that endeavor field, including (a) exposing a relevant prospective change-candidate to a positive-deviance script which is associated with the mentioned field of endeavor, and (b) in a computer-system-delivered, plural-stage series of verbally-based exercises, and using a pattern describable as “read, feedback, and adapt”, directing the change-candidate, via encouraged, self-first-person verbal expression, and related interaction with the computer system, transformably to embody and personify the positive-deviance script.

### CROSS REFERENCE TO RELATED APPLICATION

This application claims priority to currently co-pending U.S. Provisional Patent Application Ser. No. 61/132,236, filed Jun. 16, 2008, for “Computer-Based First-Person Behavioral Change Methodology”. The entire disclosure content of that provisional application is hereby incorporated herein by reference.

### BACKGROUND AND SUMMARY OF THE INVENTION

There is today in many fields or areas of endeavor an interest in truly and indelibly transforming a person's thinking and behavior in a particular area so as to improve matters like that person's performance, approaches to tasks, effectiveness, efficiency, and dedication, etc. The areas, or fields, characterized with such interest include a huge variety of activities, such as many forms of business activities, and the interest in achieving such transforming may be personal for one's self, managerial in relation to others, or both. A person engaged in the transformation process of the invention is referred to herein as a change candidate.

The present invention offers a unique and a strikingly successful approach to promoting and achieving relevant, important, personal behavioral changes and transformations in all areas and activities of life, and for all of the reasons suggested above.

More specifically, and looking with greater focus on the matter of effecting indelible, personal behavioral transformation as outlined, in all such fields of activity, there always exist, in addition to many others, people who are recognized to be, and who are justifiably admired for being, what are known as “positive deviants”, as defined below. In accordance with practice of the present invention, and as will be seen, positive deviancy is “the model”, and it is in the field- or endeavor-centric behavioral images of such positive deviants that effective transformations, to that admired status, of non-positive-deviant others in a field are, and may be, promoted and created.

While the term “positive deviant” is generally well known in the arena of personal behavioral characteristics, and while there are many similar definitions regarding what the features of a positive deviant are, for the purpose of invention disclosure herein, a positive deviant is defined as someone who ethically achieves extraordinary success with the same resources and conditions as others by developing substantive innovations for a particular domain that impact significant numbers of other people. Within this definition, certain phrases therein have the following, important meanings and significances:
“achieves extraordinary success”—positive deviants are consistently and systematically the top performers in an organization. They always outperform the majority of people;
“ethically, with the same resources and conditions as others”—positive deviants achieve success under the same conditions as others without violating ethical or legal limitations;
“by developing substantive innovations”—positive deviants find innovative ways to utilize existing resources. They are exceedingly innovative about solving practical problems;
“for a particular domain”—positive deviants are experts in a particular domain (e.g., restaurant management, women's apparel sales, etc.) that is the focus of their interest and innovation. Someone can be a positive deviant in one domain and not be considered a positive deviant in relation to anything else which he or she does;
“impact significant numbers of other people”—positive deviants' innovations are ones that have been shown to have value for large groups of people. Many people have ideas. Positive deviants have ideas that positively affect many others.

In the setting, then, of personal behavioral transformation, the present invention relates to promoting and effecting a behavioral change toward positive-deviancy in a person who, as mentioned above, is referred to herein as a change-candidate, and who is engaged in a particular, selected field of endeavor, such as some business field. The so-called “business field”, generally, is employed herein as a good, representative, invention-description field wherein the features of the present invention easily stand out for understanding. In particular, it is a field wherein the invention has been found to offer particular utility.

Notwithstanding this assertion, those skilled in the art will immediately recognize that the invention is not limited to the business field.

According to the invention, which is preferably dependently implemented, over time, through the predictably and repetitively consistent machine behavior of a computer and an associated, computer-based user interface, aided, as appropriate, by initial, and thereafter occasional, amounts of personal-expert, and/or computer-system-delivered, prompting, coaching, guidance and encouragement with respect to how to use that interface and the first-person-expression transformation processes of the invention, selected phases of activity which are relevant to things that take place in an identified field of endeavor, as such phases would be expressed, performed and understood by a person known as a positive deviant in the field, are verbally characterized in a special manner and in the first person to a change candidate. Such verbal characterization is done via carefully constructed and expressed, preferably character-count-limited, power-word and power-phrase statements that are based upon research and the collection of positive-deviant first-person statements deemed to be relevant to those selected phases in the endeavor field. These statements, sourced by positive deviants, are referred to herein collectively both as a distillate change-model, and as a positive-deviance script.

A change candidate is taken effectively through these various phases, and, during each phase, is exposed in various ways to (i.e., is presented with) first-person, positive-deviant model statements in readable form which the change candidate reviews, and then, with guidance, re-expresses in an original (i.e., in the change candidate's own words—referred to herein as a self-first-person verbal expression), first-person form, preferably speaking this origination of re-expression out loud as a verbal exercise, and then entering and recording it manually in written, computer-screen-displayed script through the provided computer interface. Personal, lasting, behavioral change and transformation, toward positive deviancy, indeed, remarkably indelible such change and transformation, occur dramatically in and throughout this unique, positive-deviancy based, first-person verbalization process.

The change activity which takes place, in accordance with practice of the present invention, is significantly promoted by the fact that each change-candidate is prompted to behave entirely in a first-person manner, so as to embody, personify, and “own/possess” that candidate's originated, first-person re-expression of the thoughts, information, etc., initially provided, during, or in relation to, a phase, or a portion of a phase, by a furnished, positive-deviance statement.

In a sense, and in a very modest way, the practice of this invention has a distant relationship to what occurs between a stage director and an actor, where the actor is presented with a character and a script associated with that character, and, if successfully directed, effectively assimilates/becomes that character, as distinguished from simply pretending to be the character. The difference in acting behavior where real assimilation and “becoming” has occurred is significant and readily discernable.

Whereas, however, stage-direction, as just generally described, is aimed at arming an actor to perform a character's role non-indelibly for a limited period of time, and in a setting where that actor will, thereafter, be asked to perform many other roles, in the practice of the present invention, the behavioral change to be implemented is intended to create a long-lasting, and indeed permanent change and transformation which is to become demonstrably evident in the first-person, daily behavior of a change candidate.

As will be seen in the detailed description below of a preferred and best-mode manner of implementing the present invention, the basic, or foundation, features, principles and steps of the invention are implemented, as just above generally mentioned, in each of several-field-of-endeavor-relevant phases. In the world of business, and specifically in the business-world market-forecasting facet thereof which is presented herein for illustrating purposes, six initial, and three following, phases are representatively described. The six initial phases are identified as Objective, Big Steps, Principles, Tasks, Team, and Risks. The three following phases are identified as Progress, Risks, and Issues.

While more will be said about these several, illustrative, business-world phases later herein, it should be recognized that different, specific, endeavor-field phases may naturally and differently be defined for recognition in relation to different fields of endeavor wherein practice of the present invention is to be implemented. Accordingly, it should be understood that the field phases, per se, associated with a particular field of endeavor do not form part of the present invention.

In relation to the above-expressed background of and for the present invention, the invention may be described generally, and in a high-level fashion, as a method for transforming, from outside of, to within, the realm of positive deviance behavior, the behavior of a non-positive-deviant person engaged in a selected field of endeavor including the steps of: (a) treating such a person as a positive-deviance transformable, change-candidate; (b) collecting, and distilling to an expressible, verbal change-model, a positive-deviance profile, or script, in the relevant, selected field; (c) expressing the distillate change-model in the form of an intended, first-person, positive-deviance, model statement; (d) presenting the model statement in a readable form to the change-candidate; (e) in relation to such presenting, coaching and thereby guiding and encouraging the change-candidate (1) to read, out loud, the model statement, (2) thereafter, with appropriate coaching feedback, to re-express (adapt) it, out loud, in the change-candidate's own, first-person words, and (3) then to record appropriately, in the first person, those change-candidate words; and (f) collectively, by such treating, collecting and distilling, expressing, presenting, coaching, encouraging and guiding, at least partially effecting in the change-candidate the intended, behavioral transformation.

It will usually typically be the case that an overall transformation process will involve a number of presented, positive-deviant profile, positive-deviant model statements, linked with the just generally outlined “read, feedback, and adapt” interengagement between a change candidate an a coach/guide (personal, or computer-system-based).

Another high-level way of expressing the invention generally is that it involves a first-person, field-of-endeavor-associated method for transforming, toward positive deviance, a behavioral change-candidate's performance characteristics in that endeavor field, including (a) exposing a relevant prospective change-candidate to a positive-deviance script which is associated with the mentioned field of endeavor, and (b), in a computer-system-delivered, plural-stage series of verbally-based exercises, directing the change-candidate, via encouraged, self-first-person verbal expression, and related interaction with the computer system, transformably to embody and personify the positive-deviance script.

Still a further general and high-level way of characterizing the invention is to describe it as a first-person, positive-deviance, behavioral change and transformation methodology associated with a particular field of endeavor, and aimed at transforming, toward positive deviance, selected behavioral characteristics of a change-candidate in that field, including the steps of (a) presenting to the change-candidate a positive-deviance-sourced script relevant to the field, and (b) through prompting, and via prompted first-person, self-created expression originated by the change-candidate, promoting an assimilation transformation of the change-candidate into a person exhibiting an effective personification of the positive-deviant script source.

These and other features and advantages of the methodology of the present invention will become more fully apparent as the detailed description which follows below is read in conjunction with the accompanying drawings.

### DESCRIPTIONS OF THE DRAWINGS

FIG. 1 is a simplified, partly fragmentary, block/schematic drawing illustrating one preferred and best-mode manner of expressing the behavioral transformation methodology of the present invention.

FIG. 2 is a block/schematic drawing picturing a core behavioral transformation practice of the present invention involving the role of first-person expression.

FIG. 3 is a block/schematic sequence diagram showing six, representative, initial transformation-activity phases that are involved in one illustrative practice of the invention associated with a particular field-of-endeavor facet (market forecasting) in the world of business.

FIG. 4 is a block/schematic diagram which is related to FIG. 3, showing three, representative, subsequent, field-of-endeavor, transformation-activity phases that are engaged in following going through the six phases that are pictured in FIG. 3.

FIGS. 5-13, inclusive, present computer-interface screenshots that individually, and sequentially respectively, furnish specific illustrations of the six initial and the three following field-of-endeavor, transformation-activity phases that are shown in FIGS. 3 and 4, respectively.

FIG. 5 specifically is a presentation of an “Objective-phase” screenshot modified with two, added “blocks” of sidebar language presented to illustrate how personal-assistance training and guiding (or computer-assistance training and guiding) may be employed in a mode of interactive dialogue during a transformation-activity phase to promote first-person, change-candidate adaptation of positive-deviancy thinking and behavior.

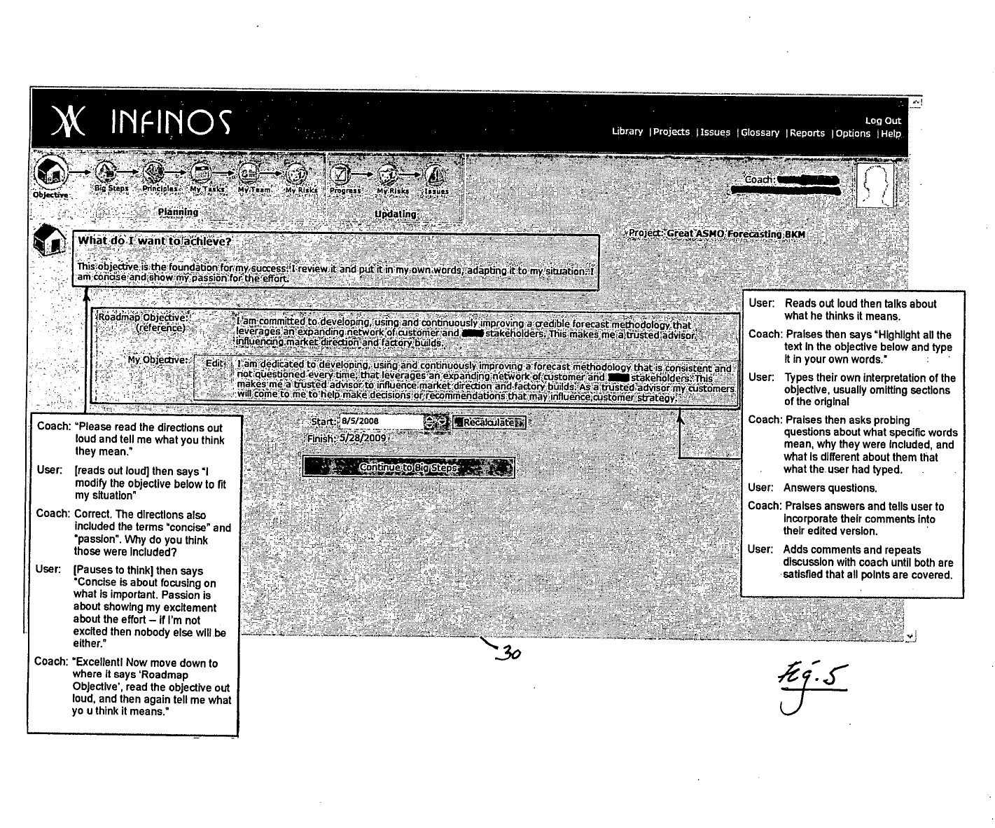

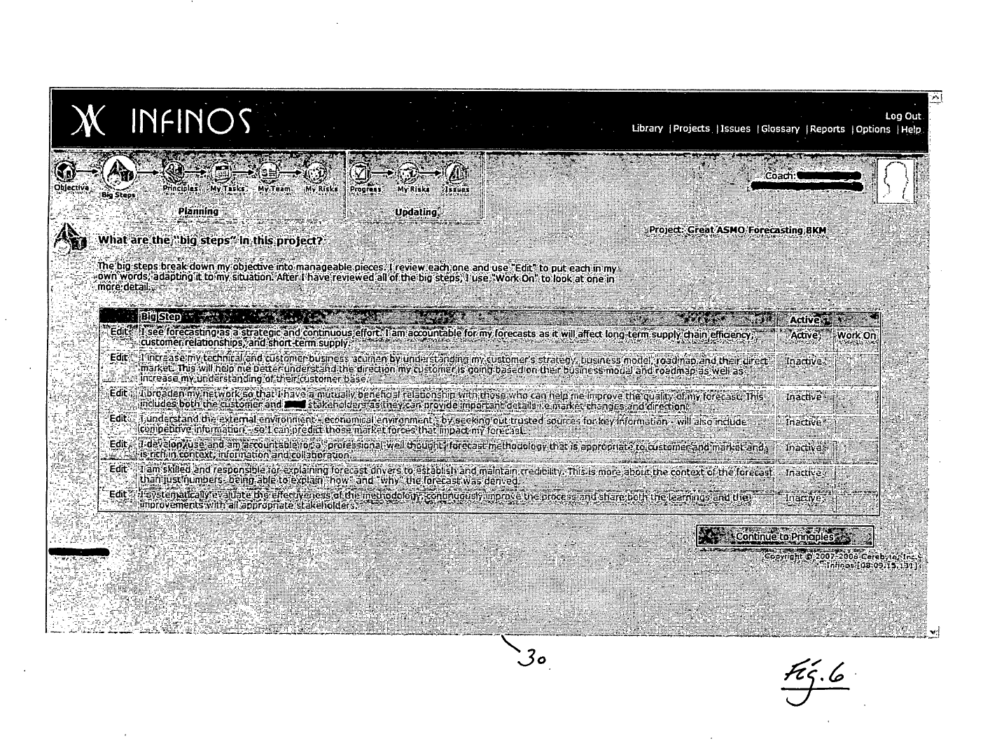

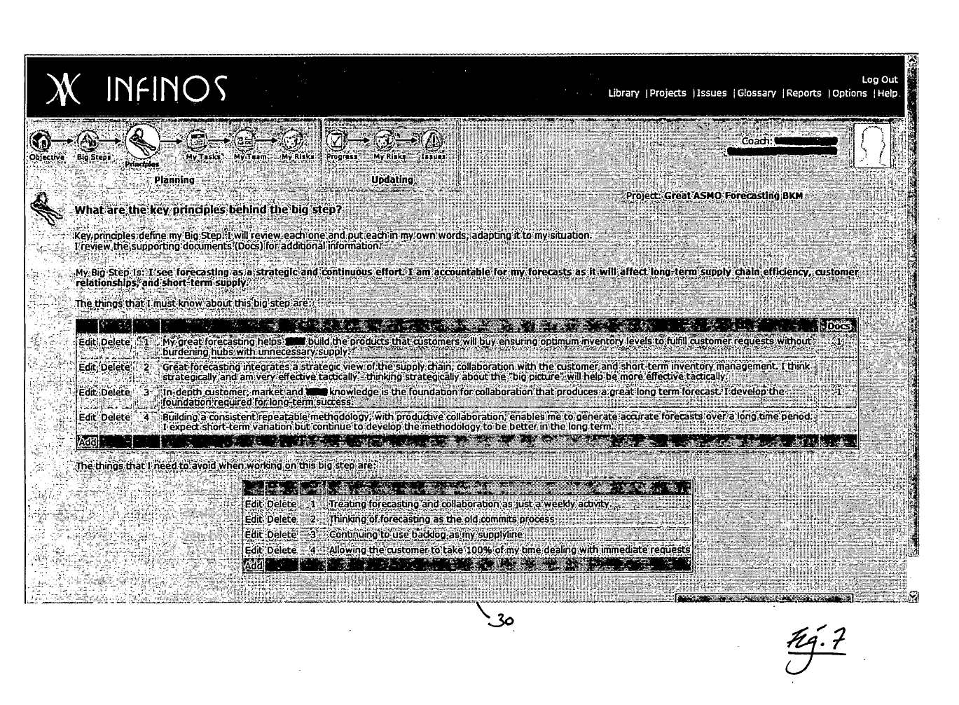

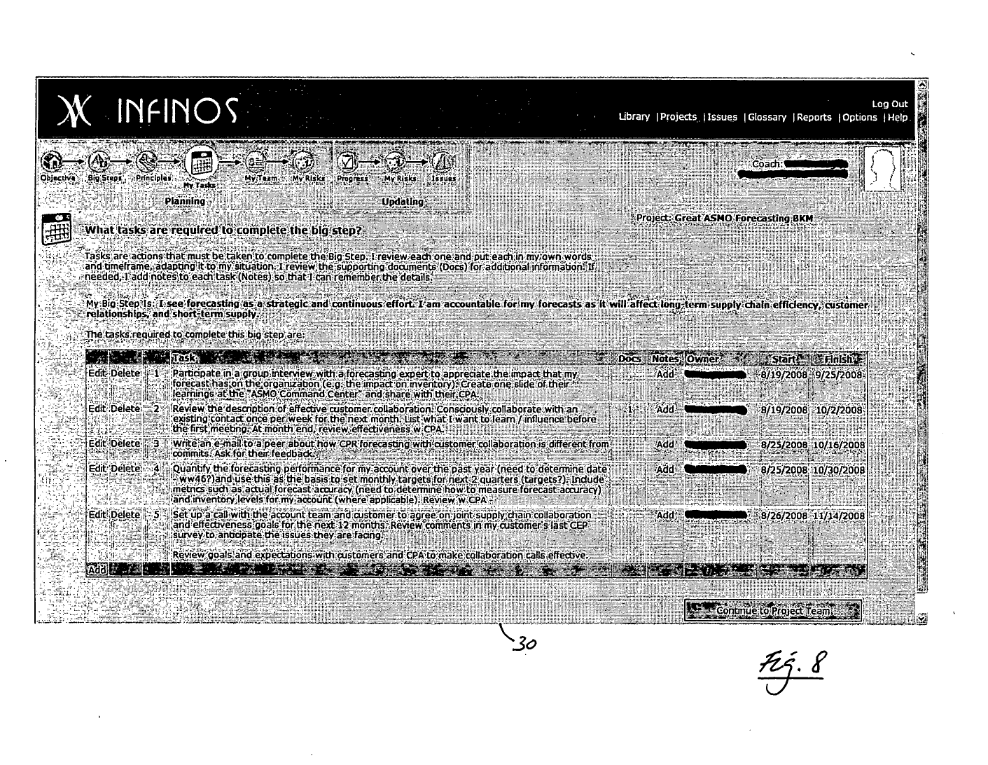

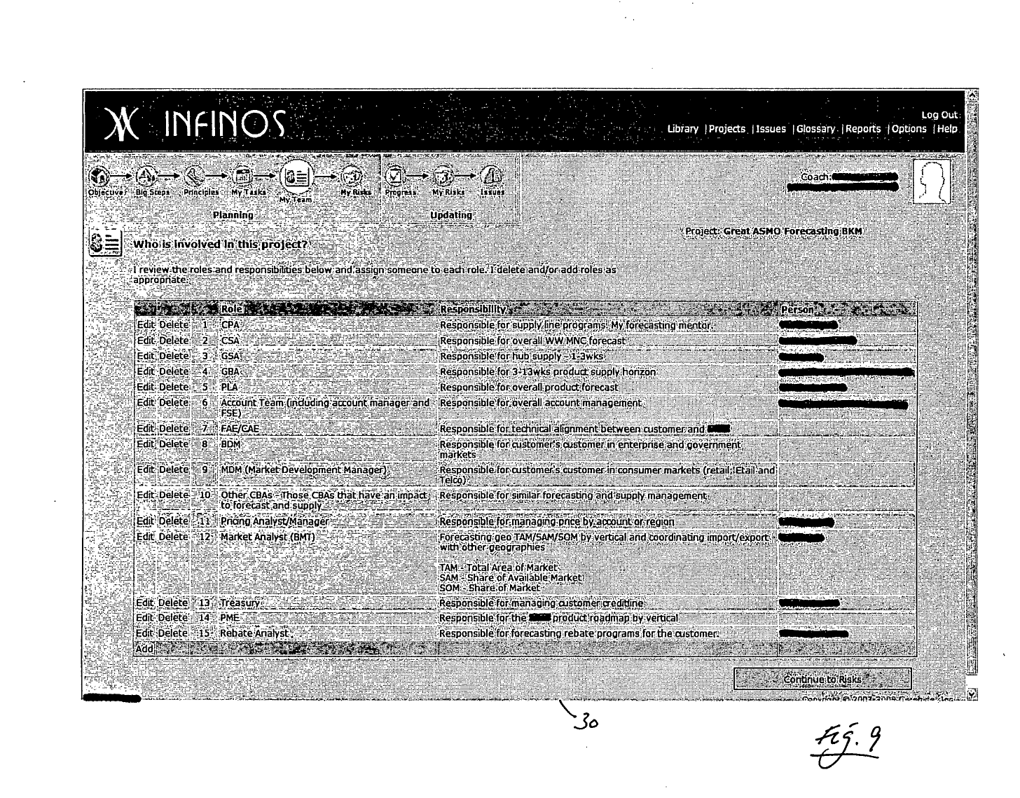

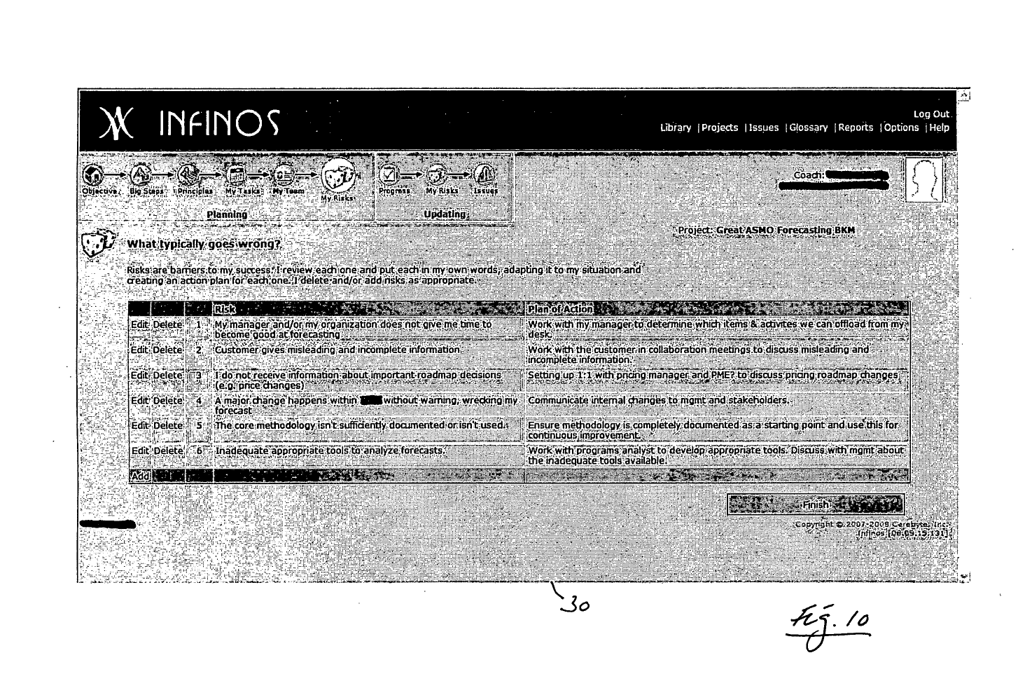

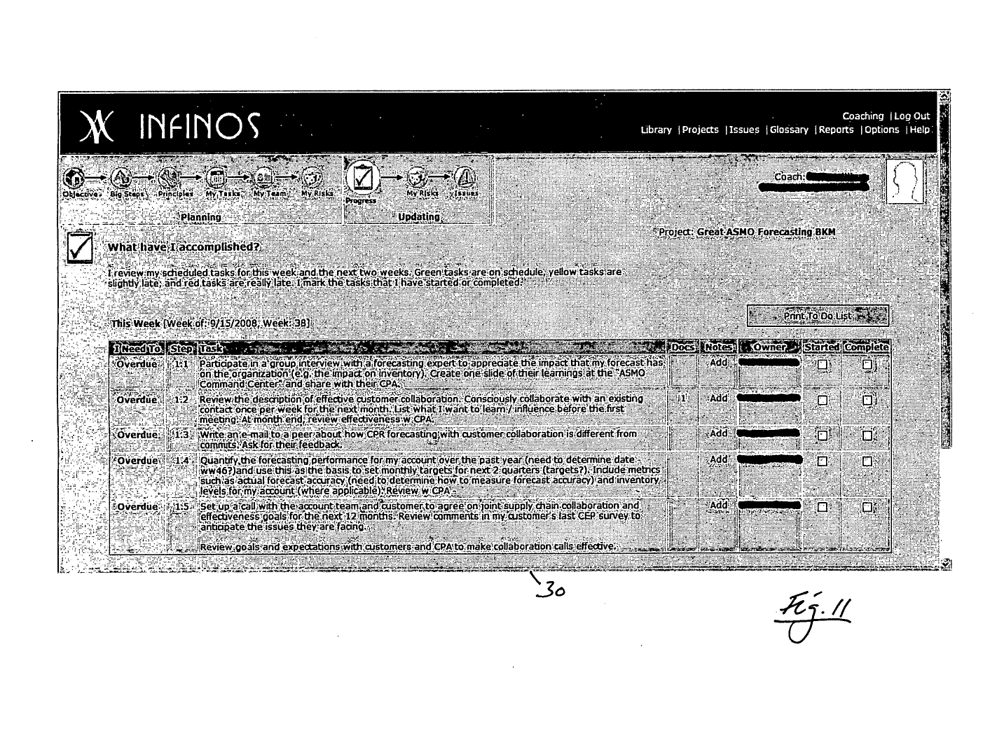

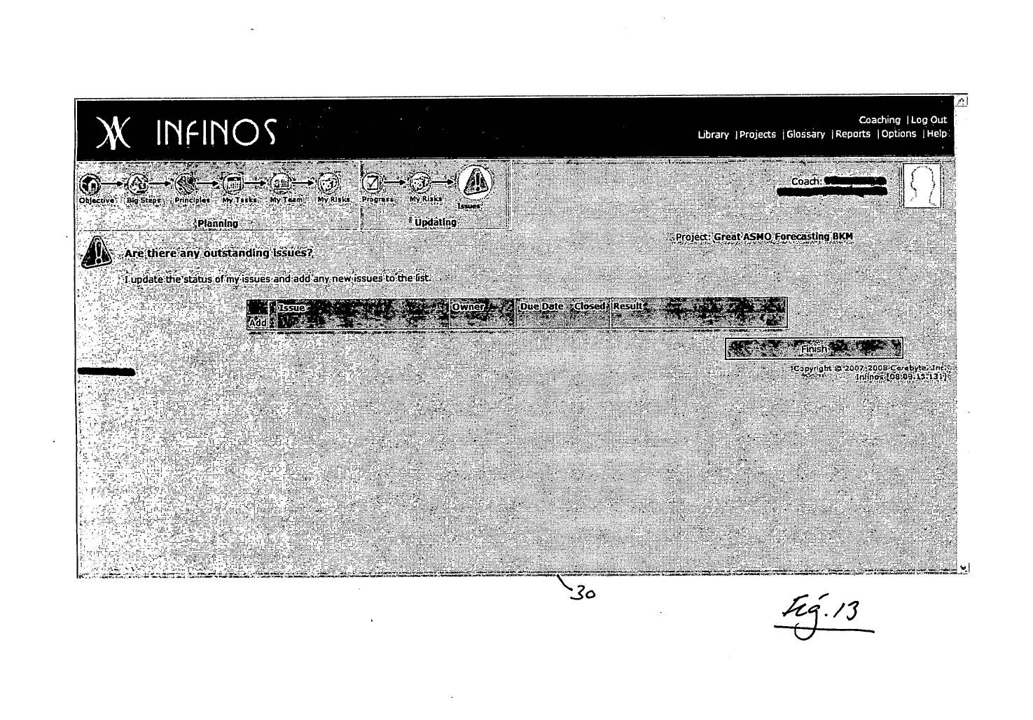

One should note that at several locations in FIGS. 5-13, inclusive, personal and corporate name information has been redacted, and that in relevant text below herein, where appropriate, blank spaces have been substituted for the redacted names.

### DETAILED DESCRIPTION OF THE INVENTION

Practice of the present invention in a particular field of endeavor is based fundamentally upon having a relevant candidate for transformation, or change, referred to herein as the previously mentioned change candidate, effectively adopt, and “assimilate”, the thinking and behavioral patterns of a field-specific positive deviant through the specialized use of first-person power statements (a positive-deviance script) derived from relevant positive deviancy. In this context, we have discovered that the very specialized use of first-person, self-adaptive and -adapted expression, linked to carefully distilled and tailored, field-based, first-person positive-deviant power-impact statements, lies at the heart of the power and success of the methodology of the invention.

To practice the invention in a selected field, one begins by identifying positive deviants in that field through the relatively simple, straight-forward and remarkably reliable process of asking people engaged in the field just the following three questions, say, with respect to one or more identified, field-associated function(s), problem(s), etc.:
1. Who are the people you most respect for their ability to perform this (identified) function?
2. If you have a problem in this (identified) area, are these (from the answers to question 1) the people to whom you go for a solution?
3. When these people tell you how to solve a particular problem, etc., do you both believe them, and then act on their ideas and suggestions?

People who are sifted and identified through the collective mesh created by these questions are reliably characterizable as positive deviants.

These identified positive deviants are then preferably gathered as a group, and interviewed in a manner designed to stir conversation among them about the field of endeavor in which they are commonly considered to be such deviants. This is done with the intent of gathering and distilling and compiling from their comments a positive-deviance profile in the collective form of concise, first-person statements, referred to herein as expressible, verbal, change-model statements, or as a distillate change-model, reflecting how a positive deviant in the field thinks about, talks about, feels about, views, etc., key areas, matters, opportunities, challenges, phases, etc. that are associated with how they go about doing what they do so well in the relevant field, i.e., performing successfully in that field.

In the context of preparing one's self as a change candidate to engage in, and/or to encourage another as a change candidate to engage in, a personal behavioral transformation based on positive deviancy in the practice of the present invention, it will be apparent to those skilled in the art that it will be necessary to prepare, in almost all instances, from positive-deviant interviews, a suitable family, or collection, or range, of plural, positive-deviant statements which appropriately relate to different aspects of the particular field of endeavor associated with the prospective transformation. It will also be apparent to those skilled in the art that, even in the context of a particular field of endeavor, and with respect to the interviews that are conducted with positive deviants in the field, the selection of statement topics, and the specific statement aspects from deviants which are selected for the creation of what are referred to herein as model statements to be presented to change candidates, may be entirely different depending upon particular circumstances, and, of course, upon the thinking and intent of the person or the people who create the model statements for presentation.

Having said this, and recognizing, therefore, that a great deal of diversity will characterize appropriately usable model statements in the practice of the present invention, there are certain considerations respecting the constructions of these statements which are, in our view, extremely important to take into account in order to prepare for the most successful practice experience with the invention.

Of first importance, of course, is that a constructed change-model statement which bears upon an aspect of a field of endeavor, such as a statement regarding an objective to be achieved at some point in the engaging of an activity in the field, come substantially directly from comments made by one or more interviewed positive deviants. After all, it is the characteristics of such deviants that are intended to define an important basis for the practice of the invention.

Second and third important considerations are that, in the construction of a proposed positive-deviance model statement, that statement should be expressed solidly in the first person (much use of “I” and “my”), and should preferably contain a very high density of (i.e., be densified with) so-called power words and or power phrases, that is, words and phrases which have the potential for conveying high social and/or moral imperatives, and particularly strong concepts, beliefs, emotions, etc. In a featured illustration of a positive-deviancy model “Objective” statement which will be discussed more fully below in the context of what is shown in FIG. 5 in the drawings, the so-called power words and power phrases contained in that statement are highlighted for attention. In this context, experience has shown that model statements built from a foundation of positive-deviant interviews tend naturally to contain, without any special fabrication or artifice, a notable population of such power words and power phrases.

A final consideration regarding the construction of a viable model statement is that it should, preferably, though not always necessarily, be constructed with an intentionally constrained-range character count, including spaces and punctuations in the count, and that that range should preferably be from about 190-characters to about 250-characters. Within this range, we have found, further, that an even more constrained, and more highly preferred range, is defined from about 190-characters to about 210-characters. It is our belief and observation that fairly strict observance to this character-count range consideration can often be important.

In relation to the model-statement character-count question, we have determined that a total character count of about 210-characters is optimum for transferring to a listener/reader the content of a model statement defined by that count. We have found, for example, that while a character count up to the mentioned 250-character count is acceptable, listening and reading retention drops off dramatically above this character count number. We have found further that almost no significant information retention occurs where a character count rises above about 300-characters.

With the above thoughts in place that are relevant to the development and structuring of positive-deviancy models statements, or scripts, which will be used in the practice of the present invention, let us turn attention now to the drawings herein for a further elaboration and illustration of the structure and practice of the invention.

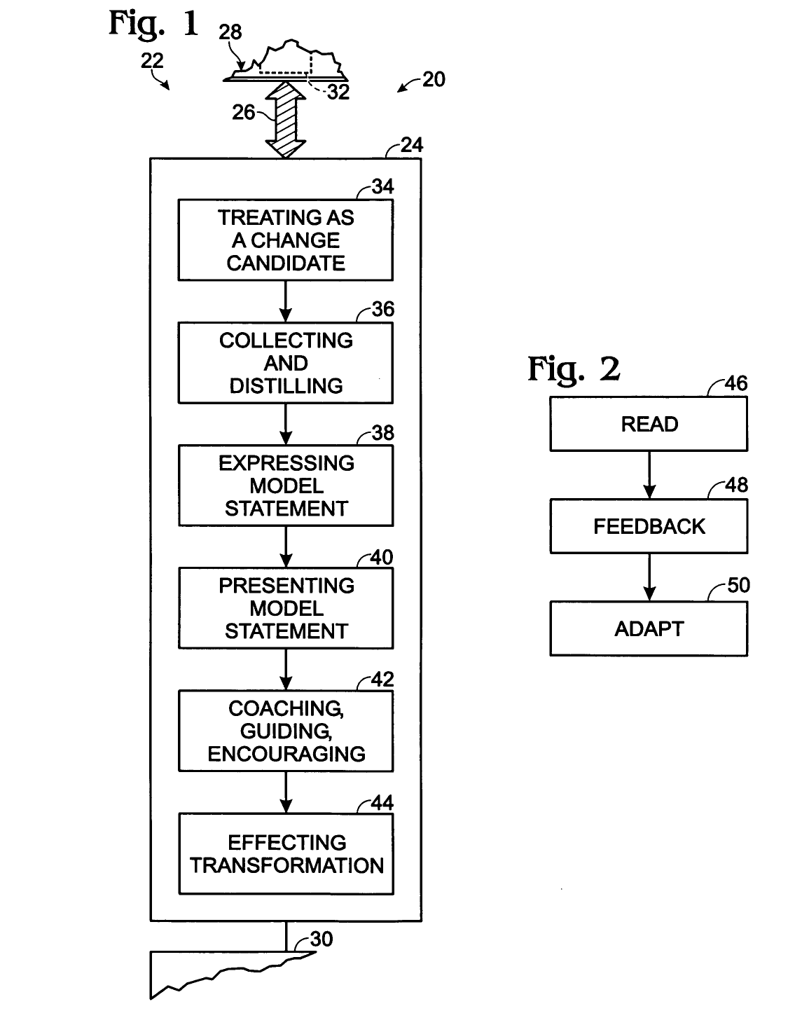

Turning attention first of all to FIG. 1, the structure and the methodology of the present invention are indicated in schematic and block form generally at 20. From a structural point of view, included in what is shown at 20 in this figure are a computer information network system 22 possessing (a) one or more conventional, suitably programmed, digital computers, such as the computer represented by block 24, and (b) an appropriately data-flow-connected (see the connection illustrated at 26) electronic information network 28, such as the Internet. Network 28, which is also conventional in construction, per se, is represented only fragmentarily in FIG. 1, and in what might be thought of as being a cloud form (clearly understood by those skilled in the art).

Computer 24 includes what is referred to herein as a change-candidate computer-display interaction interface 30 which is shown connected, and only fragmentarily, at the base of the computer in FIG. 1, and in solid outline in each of FIGS. 5-13, inclusive. Computer 24 operates in conjunction with various input/out information that is entered through and presented on interface 30. The computer is driven by what is termed herein interactive, network-stored, network-communicated, network-available, positive-deviance, behavioral-transformation programming, which programming, as stored information, is illustrated fragmentarily by dashed outline 32 in FIG. 1.

This programming “sits resident” in an entirely conventional network data-storage fashion in electronic Internet cloud 28, and as will become apparent to those skilled in the relevant art (from a reading of the detailed description of this invention, and in terms of the operational facets of the invention as such are explained herein), may be entirely conventional in construction, and readily designed for operation, in any one of a number of suitable, conventional manners, by such skilled persons. Accordingly, no details of programming 32 are provided herein. It will be understood that, in the operation of the system and methodology of the present invention, significant data transformations take place which relate to the storage, accessing, flowing and operational use of information contained in programming 32.

From the description given below presenting a typical, representative practice of the invention involving employment of a computer and its display interface, such as computer 24 and its display interface 30, it will be apparent to those skilled in the art that electronic computer circuitry, and a communication network, such as the Internet, play important roles in furnishing consistency in the manners in which change candidates are guided and encouraged to effect the intended positive-deviancy field-of-endeavor transformations which lie at the heart of practice of the present invention. And, as has been mentioned already, a computer network-based system may play an important role, either laterally supportively, or directly independently, in furnishing coaching assistance to a change candidate.

Continuing with a focus particularly on FIG. 1, six blocks 34, 36, 38, 40, 42, 44, which are shown operationally interconnected in an appropriate operational flow sequence by downwardly pointing, arrow-headed lines in FIG. 1, illustrate and represent key steps, as outlined earlier herein, involved in the practice of one preferred and best-mode, high-level-expressed form of the methodology of the present invention.

These six blocks specifically illustrate a method for transforming, from outside of, to within, the realm of positive deviance behavior, the behavior of a non-positive-deviant (change-candidate) person engaged in a selected field of endeavor. As will be seen, a selected field of endeavor which has been chosen herein for illustration purposes, and which is more specifically pictured in the content provided in FIGS. 5-13, inclusive, involves a facet of the world of business referred to as market forecasting.

Specifically, the six, method-step blocks which have just been identified in FIG. 1 specifically represent the steps of (a) treating a non-positive-deviant person as a positive-deviance-transformable change candidate (block 34), (b) collecting, and distilling to an expressible, verbal change-model, a positive-deviance profile in the relevant, selected field (block 36), (c) expressing the distillate change-model in the form of an intended, first-person, positive-deviance, model statement—a positive-deviance, script statement—(block 38), (d) presenting the model statement in a readable form to a change candidate (block 40), (e) in relation to such presenting, coaching and thereby guiding and encouraging the change candidate (1) to read, out loud, the model statement, (2) thereafter to re-express it, out loud, in the change-candidate's own, first-person words, and (3) then to record appropriately, in the first person, those change-candidate words (block 42), and (f) collectively, by such treating, collecting and distilling, expressing, presenting, coaching, encouraging and guiding, at least partially effecting in the change-candidate the intended, behavioral transformation (block 44).

From what has already been presented hereinabove, it will be apparent to those skilled in the art that the several, other, high-level ways of viewing the basic steps of the present invention may easily be seen to be represented effectively in the sequential layout of the invention steps as generally illustrated and presented in FIG. 1. Accordingly, separate drawing figures block-diagramming these other high-level expressions of the invention have not been specifically included.

Invention step 34 is certainly self-explanatory.

The steps represented by blocks 36, 38 have been thoroughly explained above in conjunction with the discussion involving (a) interviewing positive deviants, (b) collecting positive-deviance statements from these people, and (c) distilling these statements into, and in forming them for expression in, power-word/power-phrase model statements designed for appropriate presentation to one or more change candidate(s).

Regarding the additional invention steps that are block-illustrated in FIG. 1, without any requirement for special elaboration, an understanding of the method steps illustrated by blocks 40, 42, 44 will become naturally apparent from the general discussion appearing below regarding FIGS. 5-13, inclusive. However, before specifically turning to those steps and those drawings, we direct attention now specifically to FIG. 2 in the drawings. Here there are shown, in three, arrow-headed-line-connected blocks 46, 48, 50 which are labeled, respectively, “Read”, Feedback”, and “Adapt”.

As has been pointed out earlier herein, these three blocks, and the “read, feedback, and adapt” activities, or the methodology steps, which they represent, respectively, form a very important portion of the practice of the present invention. It is, effectively, through the implementation of the three steps represented by these three blocks that a change candidate is recurrently and powerfully focused upon, and guided through, the key, central, integrated, invention transformation modality which is associated with: (a) reading, out loud, a carefully prepared, positive deviance model statement; (b) engaging in the realm of coaching, and associated coaching feedback, tied importantly to reviewing such a statement with the idea that a change candidate will clearly concentrate upon, and come to understand, the positive-deviance characteristics that are expressed in such a statement (all for the subsequent purpose of the change candidate's then re-expressing such a statement in the change-candidate's own words); and (c) thereafter, and very importantly, specifically verbally adapting (by the change candidate) of the initially presented positive-deviance statement into language specifically created by the change candidate to form a statement which represents how the change candidate would uniquely express, for understanding, the content of the originally presented model statement.

It is important to note also, that of fundamental importance to this read, feedback, and adapt modality of behavior, is that all statement text is presented in, intended to be understood in, and determinedly intended to be re-expressed by a change candidate in, the first person, with a strong and relentless focus upon the words “I” and “my”.

Having thus described what is illustrated for attention in FIG. 2, we direct attention now to FIGS. 3-13, inclusive.

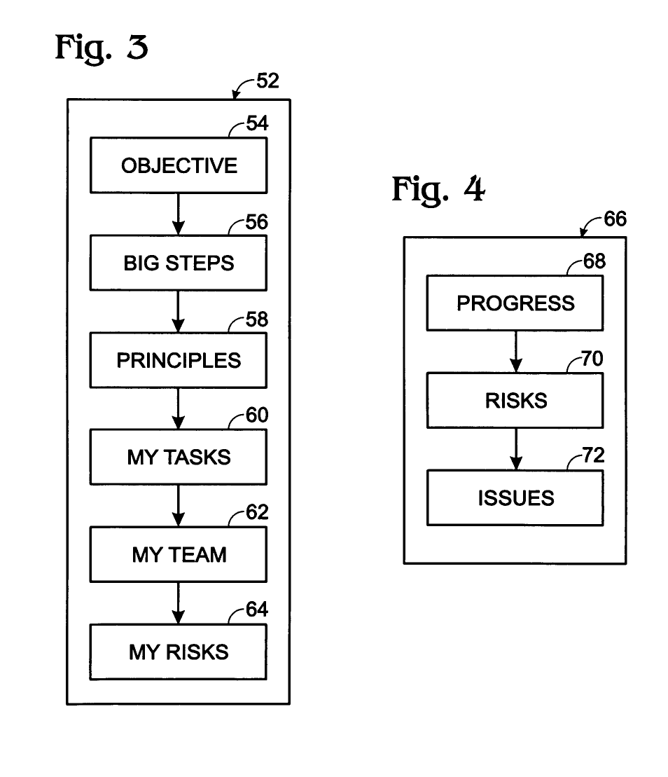

With a focus placed first upon FIGS. 3 and 4, indicated generally at 52 in FIG. 3, in blocks 54, 56, 58, 60, 62, 64, are the six, earlier-mentioned representative, “initial” transformation-relevant phases of the business-world facet of market forecasting in conjunction with which a practice of the present invention is illustrated now more specifically in the contents of FIGS. 5-13, inclusive. The labeling which is presented specifically in these six, just-mentioned blocks, directly links these blocks with the computer interface screenshots pictured in FIGS. 5-10, inclusive and respectively.

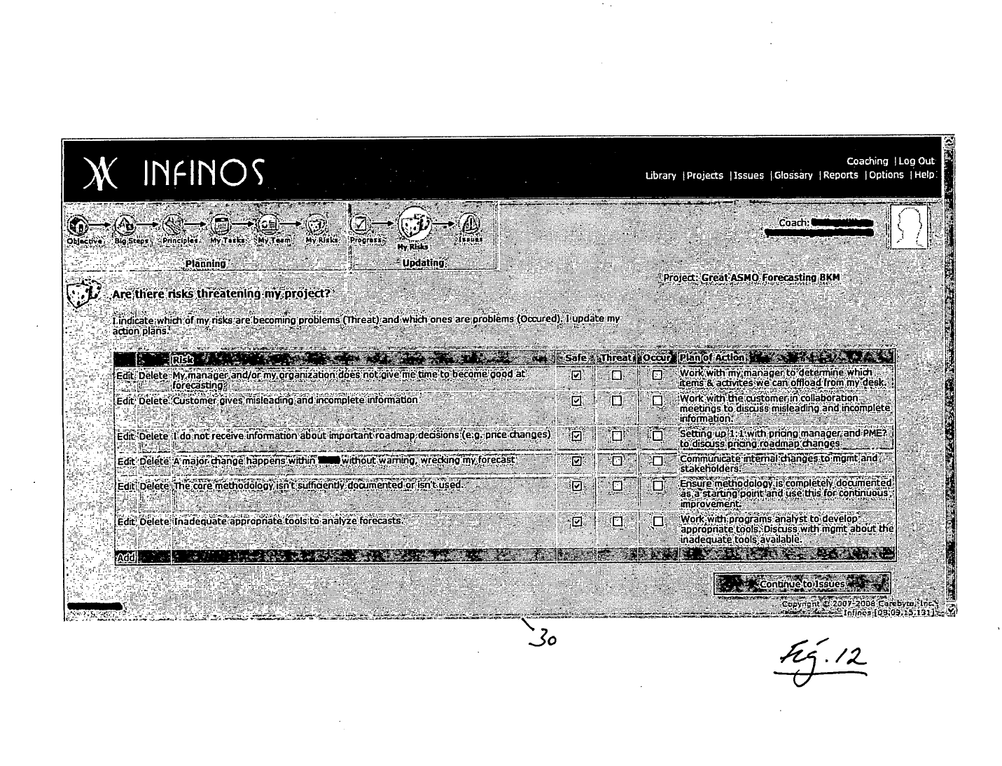

Shown at 66 generally in FIG. 4 are three blocks 68, 70, 72 which represent the three, earlier-mentioned, transformation-relevant “following” phases of the market-forecasting illustration of practice of the invention, which phases follows the six initial phases pictured in FIG. 3. These three blocks, 68, 70, 72, relate respectively to FIGS. 11-13.

As has been mentioned earlier herein, the present invention is not concerned with the details of the several (nine) phases of market forecasting which are pictured variously in FIGS. 3-13, inclusive. These nine phases of a representative business-world facet, illustrated herein to present an operational picture of how the methodology of the present invention may work in a particular field of endeavor, have their respective names pictured in with highlighted (large-circled) icons that are distributed in a full-family row of icons extending horizontally across the upper left-hand portions of the computer-interface screenshots which are pictured in FIGS. 5-13, inclusive.

While each individual phase, as will be apparent to those skilled in the art, and especially from a careful look taken at the relevant drawing figures herein, may have some appreciable depth, in the sense that, regarding certain ones of them, various stages or a sub-phases are or may be involved, what is important in relation to the practice of the present invention is that positive-deviance statements that are employed during some or all of these sub phases are created and employed in the “read, feedback, and adapt” modality which has been described above as lying importantly within the practice of the present invention. Accordingly, we do not, in any detailed, descriptive manner herein, other than through presenting the respective screenshots in the relevant drawing figures, further elaborate substantive elements of the nine phases of the representative, market forecasting illustration of practice of the invention.

Notwithstanding this disclaimer about the non-invention characteristic of the substantive business-facet phases illustrated in the drawings, we here call attention specifically to FIG. 5 which, on opposite, left and right sides, includes blocks of representative coaching and user(change-candidate)-response dialogue that, among other things, clearly demonstrate an application of the important “read, feedback, and adapt” methodology of the invention.

We also employ FIG. 5, which is associated with the “Objective” phase of the illustrated market forecasting facet of business, to discuss further the special verbal structure of a change-candidate-presented positive-deviance model statement, and as well, a change-candidate-recorded re-expression of that statement, formed in the change candidate's own words, and following the associated, dialogue-illustrated “read, feedback, and adapt” practice just mentioned above.

The presented, positive-deviance model statement, including shaded text to indicate the incorporation of power words and phrases, is:
I am committed to developing, using and continuously improving a credible forecast methodology that leverages an expanding network of customer and (redacted name) stakeholders. This makes me a trusted advisor influencing market direction and factory builds.

The feedback-influenced, change-candidate-adapted re-expression of this statement is:
I am dedicated to developing, using and continuously improving a forecast methodology that is consistent and not questioned every time, that leverages an expanding network of customer and (redacted name) stakeholders. This makes me a trusted advisor to influence market direction and factory builds. As a trusted advisor my customers will come to me to help make decisions or recommendations that may influence customer strategy.

This completes now a disclosure of the invention methodology. From this disclosure, it is our view that those skilled in the art, reviewing what has been said above about the methodology of the present invention, read in the context of the illustrations presented in FIGS. 5-13, will appreciate how practice of the present invention may be employed in a very wide range of fields of endeavor, utilizing all of the basic steps of the invention which have been set forth herein. Those skilled in the art will also, certainly, appreciate how variations and modifications, as appropriate, may be made to create a specific, tailored practice of the invention designed to fit appropriately into a particular environment for performing personal behavioral-change transformations toward positive deviancy, as contemplated by the invention.

In the areas where we have a practiced this invention in accordance with the teachings thereof expressed above, it has been our consistent experience that change candidates do indeed, in very indelible fashions, become transformed toward possessing and demonstrating positive-deviancy behavioral characteristics in their respective fields of endeavor.

Accordingly, while a preferred and best-mode embodiment of, and manner of practicing, the invention, and variations thereof, have been described and illustrated herein, we appreciate that other variations and modifications may be made without departing from its spirit.

We claim:

1. A method for transforming, from outside of, to within, the realm of positive deviance behavior, the behavior of a non-positive-deviant person engaged in a selected field of endeavor comprising,
treating such a person as a positive-deviance transformable, change-candidate,
collecting, and distilling to an expressible, verbal change-model, a positive-deviance profile in the relevant, selected field,
expressing the distillate change-model in the form of an intended, first-person, positive-deviance, model statement,
presenting the model statement in a readable form to the change-candidate,
in relation to said presenting, coaching and thereby guiding and encouraging the change-candidate (a) to read, out loud, the model statement, (b) thereafter to re-express it, out loud, in the change-candidate's own, first-person words, and (c) then to record appropriately, in the first person, those change-candidate words, and
collectively, by said treating, collecting and distilling, expressing, presenting, coaching, encouraging and guiding, at least partially effecting in the change-candidate the intended, behavioral transformation.

2. The method of claim 1, wherein said distilling relative to the creation of a resulting, expressible change-model includes featuring in that model verbal expressions recognizable conventionally as being characteristic of high social and/or moral imperatives.

3. The method of claim 1, wherein said coaching, in relation to encouraging first-person expression by a change-candidate, urges recurrent and consistent use by the change-candidate of the words “I” and “my”.

4. The method of claim 1, wherein said coaching, in relation to encouraging first-person expression by a change-candidate, is performed by at least one of (a) person-to-person coaching and (b) computer-system-to-person coaching.

5. The method of claim 1, wherein said distilling includes choosing from, and associating in relation to, the result of said collecting an established population of relevant, strong, conceptual, positive-deviance-enhancing power-words, and said expressing includes densifying the intended model statement with words drawn from that established population.

6. The method of claim 5, wherein the intended model statement is formed with a character count, including spaces and punctuation in the count, which lies in the constrained range of about 190- to about 250-characters.

7. The method of claim 6, wherein the intended model statement is most preferably formed with a character count, including spaces and punctuation in the count, which lies in the preferred and further constrained range of about 190- to about 210-characters.

8. The method of claim 1 which is practiced in the setting of a computer information network which is linked electronically to a change-candidate computer interface driven by and interactive with network-stored, -communicated and -available, positive-deviance behavioral-transformation programming, and wherein said presenting, and said coached reading, re-expressing and recording steps are performed, at least in part, in a setting with at least the change-candidate utilizing that interface.

9. A first-person, field-of-endeavor-associated method for transforming, toward positive deviance, a behavioral change-candidate's performance characteristics in that endeavor field, including
exposing a relevant prospective change-candidate to a first-person positive-deviance script which is associated with the mentioned field of endeavor, and
in a computer-system-delivered, plural-stage series of verbally-based exercises, directing the change-candidate, via encouraged, self-first-person verbal expression, and related interaction with the computer system, transformably to embody and personify the positive-deviance script.

10. A first-person, positive-deviance, behavioral change and transformation methodology associated with a particular field of endeavor, and aimed at transforming, toward positive deviance, selected behavioral characteristics of a change-candidate in that field, said methodology comprising
presenting to the change-candidate a positive-deviance-sourced first-person script relevant to the field, and
through prompting, and via prompted first-person, self-created expression originated by the change-candidate, promoting a transformation of the change-candidate into a person exhibiting an effective personification of the positive-deviant script source.
